(19) United States
(12) Patent Application Publication
(10) Pub. No.: US 2021/0388155 A1
(43) Pub. Date: Dec. 16, 2021

(54) METHOD FOR MANUFACTURING GLYCOL-MODIFIED POLY ETHYLENE TEREPHTHALATE COPOLYMERS AND APPLICATIONS THEREOF

(71) Applicant: Chi Mei Corporation, Tainan City (TW)

(72) Inventors: Yu-Hao HUANG, Tainan City (TW); Jui-Hsi HSU, Tainan City (TW)

(21) Appl. No.: 17/307,052

(22) Filed: May 4, 2021

(30) Foreign Application Priority Data
May 4, 2020 (TW) 109114815

(51) Int. Cl. C08G 63/183; C08G 63/85; C08G 63/83; C08K 5/521

(52) U.S. Cl. CPC C08G 63/183; C08K 5/521; C08G 63/83; C08G 63/85

(57) ABSTRACT

The present invention describes a manufacturing method for a glycol-modified polyethylene terephthalate and an application for which. The manufacturing method includes the following steps. A reaction mixture is provided. The reaction mixture includes terephthalic acid, ethylene glycol, 1,4-cyclohexanedimethanol and an aqueous titanium-based catalyst. An esterification reaction and a polycondensation reaction is performed to the reaction mixture to obtain the glycol-modified polyethylene terephthalate.

This application claims the benefit of Taiwan application Serial No. 109114815, filed May 4, 2020, the subject matter of which is incorporated herein by reference.

### BACKGROUND

### Technical Field

The present disclosure relates to a manufacturing method and an application for a glycol-modified polyethylene terephthalate.

### Description of the Related Art

A phthalate polyester material, such as polyethylene terephthalate, is a polymer of high crystallinity having a creamy white color or a pale yellow color. The phthalate polyester material is a plastic material having a smooth and glossy surface. The phthalate polyester material has advantages of a wide applicable temperature range, a good physical mechanical property, a high electrical insulating property, a high creep resistance, a high fatigue resistance, a high friction resistance and a good dimensional stability, and low cost. The phthalate polyester material has been widely applied in industries of textile, plastics, thin film, and PET bottle, etc.

However, a conventional polyethylene terephthalate has a limited application range due to its lack of toughness resulted from a higher crystallinity. For increasing an added value of the polyethylene terephthalate, there has been a technique modifying polyethylene terephthalate or poly1,4-cyclohexylene dimethylene terephthalate by using a diol, such as 1,4-cyclohexanedimethanol (CHDM) or ethylene glycol (EG), so as to form a functional terephthalate copolyester material, such as polyethylene terephthalate 1,4-cyclohexanedimethanol modify (PETG) or poly1,4-cyclohexylene dimethylene terephthalate ethyleneglycol modify (PCTG), to have characteristics in better optical property, high transparency, impact resistance, heat resistance, strong gas barrier property, γ ray resistance, chemical resistance, and easy for printing, and generating no static electricity, and to be widely applicable to a molded product for industries of medicine, optics, electronic product, food/cosmetic package, signboard/storage shelf, furniture, building material, etc.

Methods for fabricating the terephthalate copolyester material having a good property can be classified by starting materials into an esterification method using terephthalic acid as a starting material, and a transesterification method using dimethyl terephthalate (DMT) as a starting material. A byproduct of the esterification method using the terephthalic acid as the starting material is water, but not methanol. Water is more easily to remove, and is more safely than methanol. Therefore, the esterification method using the terephthalic acid as the starting material is a better choice for the technique.

However, the byproduct water generated by the esterification reaction of the terephthalic acid would hydrolyze a non-aqueous catalyst usually used in the current technique, causing catalytic activity losing of the non-aqueous catalyst, and forming of an insoluble precipitate, resulting in transparency decreasing of a final product. Moreover, under a high temperature reaction condition, the ethylene glycol would dehydrate to generate a byproduct diethylene glycol (DEG). The diethylene glycol would take part in the polymerization. It makes the polyethylene terephthalate 1,4-cyclohexanedimethanol modify (PETG) having a diethylene glycol unit in a molecular chain of the PETG. It results in softening of the molecular chain and reducing of a glass transition temperature (Tg) of the polyethylene terephthalate 1,4-cyciohexanedimethanol modify (PETG), causing processing problems of lack of mechanical property and heat stability. As the activity of the non-aqueous catalyst decreases due to a hydrolysis in the esterification reaction, a react time extends, which results in an increasing amount of the diethylene glycol unit in the polyester molecule. It makes the processing problems described above being worse. If the amount of non-aqueous catalyst is supplemented, the hue of the final product becomes bad.

Therefore, there are demands for providing an advanced manufacturing method for a terephthalate copolyester and an application for which for resolving the problem faced with the current technique.

### SUMMARY

An embodiment of the present disclosure discloses a manufacturing method for a glycol-modified polyethylene terephthalate, comprising the following steps. A reaction mixture is provided. The reaction mixture comprises terephthalic acid, ethylene glycol, 1,4-cyclohexanedimethanol and an aqueous titanium-based catalyst. An esterification reaction and a polycondensation reaction is performed to the reaction mixture to obtain the glycol-modified polyethylene terephthalate.

An embodiment of the present disclosure discloses a molded product manufactured by the glycol-modified polyethylene terephthalate described above.

### BRIEF DESCRIPTION OF THE DRAWINGS

FIG. 1 illustrates a relational graph of a content ratio of a titanium of a titanium-based catalyst to a diacid with a number average molecular weight of prepared polyesters of Embodiment 1 to Embodiment 3 and Comparative example 1 to Comparative example 3.

FIG. 2 illustrates a relational graph of a content ratio of a titanium of a titanium-based catalyst to a diacid with a mole ratio of a diethylene glycol unit to the diol unit of prepared polyesters of Embodiment 1 to Embodiment 3 and Comparative example 1 to Comparative example 3.

FIG. 3 illustrates a relational graph of a content ratio of a titanium of a titanium-based catalyst to a diacid with a hue value of prepared polyester in Embodiment 1 to Embodiment 3 and Comparative example 1 to Comparative example 3.

### DETAILED DESCRIPTION

The disclosure provides a manufacturing method for a glycol-modified polyethylene terephthalate and an application of which. The glycol-modified polyethylene terephthalate has a mechanical property, a good hue, a high transparency and a heat stability well.

The manufacturing method for the glycol-modified polyethylene terephthalate comprises the following steps. A reaction mixture is provided. An esterification reaction and a polycondensation reaction is performed to the reaction mixture to obtain the glycol-modified polyethylene terephthalate. The reaction mixture comprises terephthalic acid, ethylene glycol, 1,4-cyclohexanedimethanol and an aqueous titanium-based catalyst.

In an embodiment, in the reaction mixture, a content of the ethylene glycol is more than a content of the 1,4-cyclohexanedimethanol. For example, a mole number of the ethylene glycol: a mole number of the 1,4-cyclohexanedimethanol may be 2-10:1, or 5-10:1. In another embodiment, in the reaction mixture, the content of the ethylene glycol is similar with the content of the 1,4-cyclohexanedimethanol. For example, the mole number of the ethylene glycol: the mole number of the 1,4-cyclohexanedimethanol may be 1:2 to 2:1. In another embodiment, in the reaction mixture, the content of the ethylene glycol may be less than the content of the 1,4-cyclohexanedimethanol. For example, the mole number of the ethylene glycol: the mole number of the 1,4-cyclohexanedimethanol may be 1:2-10, or 1:5-10.

A mole number of the terephthalic acid: the mole number of the ethylene glycol may be 1:1-5, or 1:2-4.

The aqueous titanium-based catalyst comprises an organic acid chelates titanium(IV) complex, an organic base chelates titanium(IV) complex, or a combination thereof. For example, the organic acid chelates titanium(IV) complex comprises titanium(IV) citrate complex, lactic acid chelates titanium(IV) complex, lactic acid ammonium salt chelates titanium(IV) complex, or a combination thereof. For example, the organic base chelates titanium(IV) complex comprises titanium(IV) triethanolamine chelates complex, and so on. A content ratio of titanium of the aqueous titanium-based catalyst to a diacid of the reaction mixture is 60 ppm or more, such as 60 ppm-1000 ppm, or 60 ppm-500 ppm, or 60 ppm-100 ppm.

In some embodiments, the content ratio of the titanium of the aqueous titanium-based catalyst to the diacid (comprising the terephthalic acid) of the reaction mixture is 30 ppm or less, such as 1 ppm-30 ppm, or 5 ppm-25 ppm, or 10 ppm-25 ppm.

The titanium(IV) citrate complex uses citric acid of triprotic acid as a chelating agent, and therefore has advantages of good stability, hydrolysis resistance, high polymerization activity, and less production of defective insoluble substance, and is applicable for a wide pH range. In some embodiments of the present disclosure, the titanium(IV) citrate complex is used as the aqueous titanium-based catalyst to catalyze the esterification reaction of the terephthalic acid, the ethylene glycol and the 1,4-cyclohexanedimethanol.

In some embodiments, the reaction mixture may further comprise another kind catalyst, such as a catalyst not containing titanium, for example, comprising zinc acetate (Zn(C₂H₃O₂)₂), manganese acetate (Mn(C₂H₃O₂)₂), calcium acetate (Ca(C₂H₃O₂)₂), magnesium acetate (Mg(C₂H₃O₂)₂), cobalt acetate (Co(C₂H₃O₂)₂) or any combination thereof.

During or after the esterification reaction, the polycondensation reaction may be performed in the same one reaction tank to form polyethylene terephthalate 1,4-cyclohexanedimethanol modify or poly1,4-cyclohexylene dimethylene terephthalate ethylene glycol modify. The polycondensation reaction belongs to a type of a transesterification reaction. A main function of the transesterification reaction is removing an alcohols (such as removing ethylene glycol (EG)). In contrast, an action of the esterification reaction is removing water. The esterification reaction would produce an ester compound as a primary product and a water as a byproduct in the reaction mixture. Therefore, the esterification reaction can be determined as being complete by observation with naked eyes when the reaction mixture is shown as being transparent and not unclear. Otherwise, the esterification reaction can be determined as being complete when water is no longer produced from a distillation. A reaction temperature of the esterification reaction may be higher than a boiling point 100° C. of water, by which removal of the byproduct water can be facilitated. The reaction temperature of the esterification reaction may be 200° C. to 280° C. The reaction pressure of the esterification reaction may be 725 torr to 4145 torr.

The polycondensation reaction is the transesterification reaction (dealcoholization) between the ester compounds formed by the esterification reaction of the terephthalic acid, the ethylene glycol and the 1,4-cyclohexanedimethanol. A reaction temperature of the polycondensation reaction may be higher than the reaction temperature of the esterification reaction. The reaction temperature of the polycondensation reaction may be 240′C to 300° C. A reaction pressure of the polycondensation reaction may be lower than the reaction pressure of the esterification reaction. The reaction pressure of the polycondensation reaction may be 400 torr to 0.1 torr.

In embodiments, after the esterification reaction, and before the polycondensation reaction, a phosphorous-based stabilizer may be added into the reaction mixture. The phosphorous-based stabilizer may comprise isooctyl phosphate.

If a ratio (mole number ratio) of a content of the ethylene glycol to a total content of both the ethylene glycol and the 1,4-cyclohexanedimethanol is smaller than 50% (that is the mole number ratio of the ethylene glycol/(the ethylene glycol+the 1,4-cyclohexanedimethanol) is <50%) in the reaction tank, the generated final product has a content of poly1,4-cyclohexylene dimethylene terephthalate more than a content of polyethylene terephthalate therein, which can be referred to as poly1,4-cyclohexylene dimethylene terephthalate ethylene glycol modify (PCTG). If the ratio (mole number ratio) of the content of the ethylene glycol to the total content of both the ethylene glycol and the 1,4-cyclohexanedimethanol is larger than 50% (that is the mole number ratio of the ethylene glycol/(the ethylene glycol+the 1,4-cyclohexanedimethanol) is >50%) in the reaction tank, the generated final product has the content of polyethylene terephthalate more than the content of poly1,4-cyclohexylene dimethylene terephthalate therein, which can be referred to as polyethylene terephthalate 1,4-cyclohexanedimethanol modify (PETG).

In some embodiments of the present disclosure, in the reaction mixture, the content of the ethylene glycol is more than the content of the 1,4-cyclohexanedimethanol; and the content ratio of the titanium of the aqueous titanium-based catalyst to the diacid of the reaction mixture is 60 ppm or more. The glycol-modified polyethylene terephthalate formed by such reaction mixture has a number average molecular weight equal to or larger than 12500, such as 12500-20000, or 12500-15000, or 12500-14000.

The glycol-modified polyethylene terephthalate comprises a 1,4-cyclohexanedimethanol unit formed by the 1,4-cyclohexanedimethanol, an ethylene glycol unit formed by the ethylene glycol, and a terephthalic acid unit formed by the terephthalic acid. In the glycol-modified polyethylene terephthalate, a percentage of a mole number of the 1,4-cyclohexanedimethanol unit to a total mole number of the 1,4-cyclohexanedimethanol unit and the ethylene glycol unit is at least 10 mol %, or at least 20 mol %, or at least 30 mol %.

According to embodiments described above, the produced glycol-modified polyethylene terephthalate can be applied to a molded product, for example, for industries of medicine, optics, electronic product, food/cosmetic package, signboard/storage shelf, furniture, building material, etc., for manufacturing a product, such as a textile, a medical equipment, a container, an optical thin film, a food/cosmetic package film, and a PET bottle, etc., but not limited thereto, of having excellent optical property, high transparency, impact resistance, heat resistance, strong gas barrier property, γ ray resistance, chemical resistance, and easy for printing, and generating no static electricity.

### Embodiment 1

75.000 g (0.45 mole) of terephthalic acid (TPA), 61.589 g (0.99 mole) of ethylene glycol (EG) and 19.533 g (0.135 mole) of 1,4-cyclohexanedimethanol (CHDM) were put in a reaction tank in the atmospheric pressure, and a condensation system was turned on. Then, 0.030 g of a titanium(IV) citrate complex (aqueous titanium-based catalyst having a titanium content of 5%) (with a content ratio of the titanium to the diacid is 20 ppm), and 0.125 g of a zinc acetate ethylene glycol solution having 2 wt. % of the zinc acetate (catalyst not containing titanium, with a content ratio of zinc to the diacid is 10 ppm) were added into the reaction tank. A temperature of the reaction tank was increased to 230° C. from the room temperature, and at the same time a byproduct water was removed. The temperature of the reaction tank was maintained at 230° C. to 260° C., until the esterification reaction be was determined as being complete as the reaction mixture became transparent and not opaque observed with naked eyes. Next, after 0.028 g of a phosphorous-based stabilizer was added into the reaction mixture, the temperature of the reaction tank was increased to 270° C., and at the same time the reaction pressure was decreased to 18 torr. The reaction was performed for 4 hours. Next, the temperature of the reaction tank was increased to 275° C., and at the same time the reaction pressure was decreased to 1 torr. After the reaction was performed for 4 hours, the polycondensation reaction was complete. By which a glycol-modified polyethylene terephthalate was prepared.

### Embodiment 2 and Embodiment 3

Glycol-modified polyethylene terephthalates of Embodiment 2 and Embodiment 3 were manufactured by the same method as Embodiment 1 with the difference in the content of the titanium(IV) citrate complex in the reaction mixture. In Embodiment 2, the content of the titanium(IV) citrate complex (with a content ratio of the titanium to the diacid is 60 ppm) in the reaction mixture is 0.090 g. In Embodiment 3, the content of the titanium(IV) citrate complex (with a content ratio of the titanium to the diacid is 80 ppm) in the reaction mixture is 0.120 g.

### Comparative Example 1 to Comparative Example 3

Glycol-modified polyethylene terephthalates of Comparative example 1 to Comparative example 3 were manufactured by the same method as Embodiment 1 with the difference in that the titanium-based catalyst of the reaction mixture used a non-aqueous titanium-based catalyst: tetrabutyltitanate of a different content. The content of the tetrabutyltitanate of the reaction mixture of Comparative example 1 is 0.030 g (with a content ratio of the titanium to the diacid is 20 ppm). The content of the tetrabutyltitanate of the reaction mixture of Comparative example 2 is 0.090 g (with a content ratio of the titanium to the diacid is 60 ppm). The content of the tetrabutyltitanate of the reaction mixture of Comparative example 3 is 0.120 g (with a content ratio of the titanium to the diacid is 80 ppm).

### Comparative Example 4

56.059 g (0.338 mole) of terephthalic acid (TPA), 18.686 g (0.113 mole) of isophthalic acid (IPA) and 48.918 g (0.789 mole) of ethylene glycol (EG) were put in a reaction tank, and a condensation system was turned on. Then, 0.030 g of a titanium(IV) citrate complex (aqueous titanium-based catalyst) (with a content ratio of the titanium to the diacid is 20 ppm), and 0.125 g of a zinc acetate ethylene glycol solution having 2 wt. % of the zinc acetate (catalyst not containing titanium, with a content ratio of zinc to the diacid is 10 ppm) were added into the reaction tank. A temperature of the reaction tank was increased to 230° C. from the room temperature, and at the same time a byproduct water was removed. The temperature of the reaction tank was maintained at 230° C. to 260° C., until the esterification reaction be was determined as being complete as the reaction mixture became transparent and not opaque observed with naked eyes. Next, the temperature of the reaction tank was increased to 270° C., and at the same time the reaction pressure was decreased to 12 torr. The reaction was performed for 1 hour. Next, the temperature of the reaction tank was increased to 285° C., and at the same time the reaction pressure was decreased to 1 torr. After the reaction was performed for 6 hours, the polycondensation reaction was complete. By which a diacid modified polyethylene phthalate was prepared.

Next, the prepared polyesters of Embodiment 1 to Embodiment 3 and Comparative example 1 to Comparative example 4 were individually taken as samples and be analyzed to measure properties of number average molecular weight and hue (APHA color) value.

<Number Average Molecular Weight Measurement>

The prepared polyesters of Embodiment 1 to Embodiment 3 and Comparative example 1 to Comparative example 4 were individually dissolved in a solvent of tetrahydrofuran (THF), and then the number average molecular weights of which were measured by a gel permeation chromatography fabricated by Waters company with using polystyrene (PS) as an analysis standard. Analysis conditions of the gel permeation chromatography comprised: using a separation column of the model KD-806M; a mobile phase of tetrahydrofuran with a flow rate of 1.0 ml/min. Polymers of different molecular weights with different retention times in the column were separated by an elution with the mobile phase. A nuclear magnetic resonance (NMR) analysis was performed by using a detector of the model RI-2410 fabricated by Waters company to obtain 1H NMR spectrums. The following results can be obtained from the area ratios of the ¹H NMR spectrums:
(1) The results of mole ratios (mol %) of the diethylene glycol unit to the diol unit in the polyesters are listed in the table 1. In Embodiment 1 to Embodiment 3 and Comparative example 1 to Comparative example 3, such mole ratio is an equivalence of multiplying a value obtained by diving a mole number of a diethylene glycol unit by a total mole number of a 1,4-cyclohexanedimethanol unit and an ethylene glycol unit by 100, expressed as a percentage. Comparative example 4, such mole ratio is an equivalence of multiplying a value obtained by diving the mole number of the diethylene glycol unit by a mole number of the ethylene glycol unit by 100, expressed as a percentage.
(2) In Embodiment 1 to Embodiment 3 and Comparative example 1 to Comparative example 3, a percentage of a mole ratio of the 1,4-cyclohexanedimethanol unit to the diol unit in the polyester is equal to a percentage of a value obtained by diving the mole number of the 1,4-cyclohexanedimethanol unit by the total mole number of the 1,4-cyclohexanedimethanol unit and the ethylene glycol unit. The results of the percentage of the mole ratio of the 1,4-cyclohexanedimethanol unit to the diol unit of Embodiment 1 to Embodiment 3 and Comparative example 1 to Comparative example 3 are all 30 mol %.
(3) In Comparative example 4, a percentage of a mole ratio of an isophthalic acid unit to a diacid unit in the polyester is equal to a percentage (mol %) of a value obtained by diving a mole number of the isophthalic acid unit by a total mole number of the isophthalic acid unit and the terephthalic acid unit. The result of the percentage of the mole ratio of the isophthalic acid unit to the diacid unit of Comparative example 4 is 25 mol %.

<Hue Analysis>

The prepared polyesters of Embodiment 1 to Embodiment 3 and Comparative example 1 to Comparative example 4 were individually dissolved in acetone, and then the hue values of which were measured by a UV-VIS spectrophotometer fabricated by SHIMADZU company with using Pt—Co as an analysis standard so as to quantize yellowness indexes of the substances almost transparent. The smaller hue value indicates the better hue (lower yellowing degree).

The types and the amounts of the initial reactive materials and the catalysts of the reaction mixture for preparing the polyesters, and the property analysis results of the polyesters of Embodiment 1 to Embodiment 3 and Comparative example 1 to Comparative example 4 are listed in the table 1.

TABLE 1

| | | | Comparative | Comparative | Comparative | Embodiment | Embodiment | Embodiment | Comparative |
|---|---|---|---|---|---|---|---|---|---|
| | | | example 1 | example 2 | example 3 | 1 | 2 | 3 | example 4 |
| monomer for polymerization | | | TPA, EG, CHDM | | | | | | TPA, EG, IPA |
| catalyst | titanium-based | type | tetrabutyltitanate | | | titanium(IV) citrate complex | | | |
| | catalyst | Titanium | 20 | 60 | 80 | 20 | 60 | 80 | 20 |
| | | content (ppm) | | | | | | | |
| | catalyst not | type | zinc acetate | | | | | | |
| | containing | zinc content | 10 | | | | | | |
| | titanium | (ppm) | | | | | | | |

| | | | | | | | |
|---|---|---|---|---|---|---|---|
| Total content of catalyst (ppm) | 30 | 70 | 90 | 30 | 70 | 90 | 30 |
| number average molecular weight | 8145 | 12887 | 13052 | 8301 | 12796 | 13252 | 10162 |
| hue value | 55 | 173 | 241 | 37 | 167 | 220 | >241 |
| mole ratio of diethylene | 0.066 | 0.067 | 0.075 | 0.058 | 0.064 | 0.072% | 0.065 |
| glycol unit to diol unit (mol%) | | | | | | | |

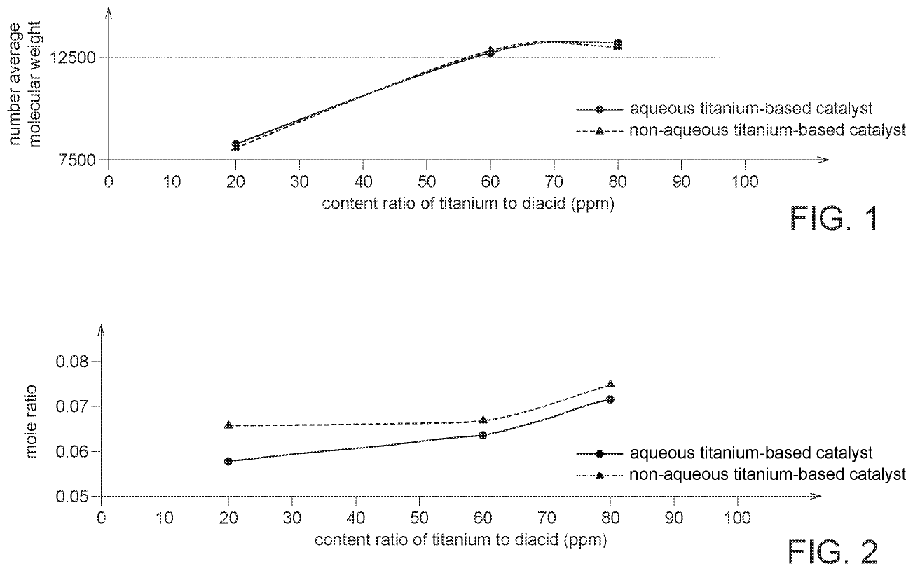

FIG. 1 illustrates a relational graph of the content ratio of the titanium of the titanium-based catalyst to the diacid with the number average molecular weight of the prepared polyesters of Embodiment 1 to Embodiment 3 and Comparative example 1 to Comparative example 3.

FIG. 2 illustrates a relational graph of the content ratio of the titanium of the titanium-based catalyst to the diacid with the mole ratio of the diethylene glycol unit to the diol unit of the prepared polyesters of Embodiment 1 to Embodiment 3 and Comparative example 1 to Comparative example 3.

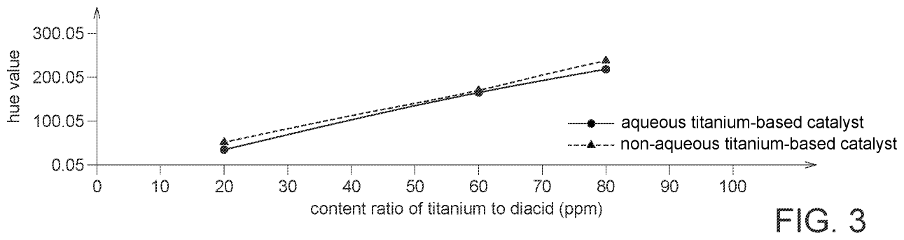

FIG. 3 illustrates a relational graph of the content ratio of the titanium of the titanium-based catalyst to the diacid with the hue value of the prepared polyester in Embodiment 1 to Embodiment 3 and Comparative example 1 to Comparative example 3.

According to the table 1, and FIG. 1 to FIG. 3, the following results can be found. From the results of Embodiment 1 to Embodiment 3 and Comparative example 1 to Comparative example 3, using the same monomers for polymerization (i.e. TPA, EG and CHDM), it can be found that, adopting the aqueous titanium(IV) citrate complex as the titanium-based catalyst can result in excellent characteristics of not easy hydrolysis, and heat stability. In addition, the byproduct water generated by the esterification reaction does not loss catalytic activity, and thus can keep having high catalytic activity in the subsequent polycondensation reaction. In the condition of the same amount of the titanium-based catalyst, the hue value (yellowing degree) of the glycol-modified polyethylene terephthalate obtained by the embodiment is lower than that of the glycol-modified polyethylene terephthalate obtained by the comparative example. Moreover, in the condition of the same amount of the titanium-based catalyst, the content of the diethylene glycol unit of the glycol-modified polyethylene terephthalate obtained in the embodiment is less than that of the glycol-modified polyethylene terephthalate obtained by the comparative example. It indicates that the aqueous titanium-based catalyst used in the embodiment does not easily be hydrolyzed to loss catalytic activity in the polycondensation reaction, and therefore can reduce the time of the polycondensation reaction. In particular, in the reaction condition of the lower amount of the catalyst (e.g. the content ratio of the titanium to the diacid being equal to or less than 30 ppm), the reducing effect to generating the diethylene glycol unit in the polyester is more apparent. That is, as the amount of the aqueous titanium-based catalyst (the titanium(IV) citrate complex) is less, the content of the diethylene glycol unit in the polyester is less, and the hue of the glycol-modified polyethylene terephthalate of final product is better. Accordingly, adopting the aqueous titanium(IV) citrate complex as the titanium-based catalyst in the esterification reaction for manufacturing the glycol-modified polyethylene terephthalate can inhibit generating of the byproduct that would cause the problem of bad hue of the final product. In addition, the aqueous titanium-based catalyst of the embodiment can dissolve in water, and does not form an undissolved substance in the reaction mixture, thus the glycol-modified polyethylene terephthalate can have a good transparency. Also, the glycol-modified polyethylene terephthalate of the embodiment has better mechanical property and heat stability.

According to the results of Comparative example 4 in the table 1, it can be found that the aqueous titanium-based catalyst is unapplicable in an esterification reaction system without 1,4-cyclohexanedimethanol (CHDM).

While the disclosure has been described by way of example and in terms of the exemplary embodiment(s), it is to be understood that the disclosure is not limited thereto. On the contrary, it is intended to cover various modifications and similar arrangements and procedures, and the scope of the appended claims therefore should be accorded the broadest interpretation so as to encompass all such modifications and similar arrangements and procedures.

What is claimed is:

1. A manufacturing method for a glycol-modified polyethylene terephthalate, comprising:
providing a reaction mixture comprising terephthalic acid, ethylene glycol, 1,4-cycohexanedimethanol and an aqueous titanium-based catalyst; and
performing an esterification reaction and a polycondensation reaction to the reaction mixture to obtain the glycol-modified polyethylene terephthalate.

2. The manufacturing method for the glycol-modified polyethylene terephthalate according to claim 1, wherein the polycondensation reaction has a reaction temperature higher than a reaction temperature of the esterification reaction, and the polycondensation reaction has a reaction pressure lower than a reaction pressure of the esterification reaction.

3. The manufacturing method for the glycol-modified polyethylene terephthalate according to claim 1, wherein the aqueous titanium-based catalyst comprises an organic acid chelates titanium(IV) complex, an organic base chelates titanium(IV) complex, or a combination thereof.

4. The manufacturing method for the glycol-modified polyethylene terephthalate according to claim 3, wherein the organic acid chelates titanium(IV) complex is selected from the group consisting of a titanium(IV) citrate complex, a lactic acid chelates titanium(IV) complex, a lactic acid ammonium salt chelates titanium(IV) complex and any combination thereof; the organic base chelates titanium(IV) complex comprises a titanium(IV) triethanolamine chelates complex.

5. The manufacturing method for the glycol-modified polyethylene terephthalate according to claim 1, wherein reaction mixture further comprises a metal-based catalyst, the metal-based catalyst is selected from the group consisting of zinc acetate, manganese acetate, calcium acetate, magnesium acetate, cobalt acetate and any combination thereof.

6. The manufacturing method for the glycol-modified polyethylene terephthalate according to claim 5, wherein in the reaction mixture, a mole number of the ethylene glycol is more than a mole number of the 1,4-cyclohexanedimethanol.

7. The manufacturing method for the glycol-modified polyethylene terephthalate according to claim 1, comprising adding a phosphorous-based stabilizer into the reaction mixture after the esterification reaction.

8. The manufacturing method for the glycol-modified polyethylene terephthalate according to claim 1, wherein the polycondensation reaction is performed during or after the esterification reaction.

9. The manufacturing method for the glycol-modified polyethylene terephthalate according to claim 1, wherein the glycol-modified polyethylene terephthalate comprises a 1,4-cyclohexanedimethanol unit formed by the 1,4-cyclohexanedimethanol, and an ethylene glycol unit formed by the ethylene glycol, in the glycol-modified polyethylene terephthalate, a percentage of a mole number of the 1,4-cyclohexanedimethanol unit to a total mole number of the 1,4-cyclohexanedimethanol unit and the ethylene glycol unit is at least 10 mol %.

10. A molded product, manufactured by the glycol-modified polyethylene terephthalate obtained by the manufacturing method according to claim 1.
